(19) United States
(12) Patent Application Publication
(10) Pub. No.: US 2021/0341402 A1
(43) Pub. Date: Nov. 4, 2021

(54) METHOD FOR CALCULATING THE STRENGTH AND THE SERVICE LIFE OF A PROCESS APPARATUS THROUGH WHICH FLUID FLOWS

(71) Applicant: Linde GmbH, Pullach (DE)

(72) Inventors: Manfred STEINBAUER, Raisting (DE); Rainer FLÜGGEN, Bichl (DE); Pascal FREKO, Eurasburg (DE); Paul HEINZ, München (DE); Alexander WOITALKA, München (DE); Patrick HAIDER, Dorfen (DE); Dino MEHANOVIC, München (DE); Thomas REITER, Bad Feilnbach (DE)

(21) Appl. No.: 17/274,536

(22) PCT Filed: Sep. 11, 2019
(86) PCT No.: PCT/EP2019/025305

§ 371 Date: Mar. 9, 2021

(30) Foreign Application Priority Data
Sep. 13, 2018 (EP) 18020448.9

(51) Int. Cl. G01N 25/00; G01K 11/3206; F28F 27/00

(52) U.S. Cl. CPC G01N 25/00; F28F 27/00; G01K 11/3206

(57) ABSTRACT

The invention relates to a method for calculating the strength and the service life of a process apparatus through which fluid flows, wherein: temperatures existing at a plurality of different points of the apparatus are measured at a first time point in order to obtain temperature measurement values (201); the temperature measurement values are used as constraints in a finite element method (203) in order to determine mechanical stresses existing at a plurality of different points in the material of the apparatus as stress values (204); the remaining service life of the material of the apparatus is determined from the obtained stress values (205); the remaining service life of the material of the apparatus is determined also in dependence on data regarding the apparatus that were determined at a second time point (207), which second time point is earlier than the first time point.

The invention relates to a method for calculating the strength and lifetime of a process apparatus through which a fluid flows and also to a computing unit and a computer program for carrying out such method.

### PRIOR ART

Process plants are usually understood to mean plants for effecting substance changes and/or substance conversions with the aid of purpose-oriented sequences of physical and/or chemical and/or biological and/or nuclear activities. Such changes and conversions typically include crushing, sieving, mixing, heat transfer, rectification, crystallization, drying, cooling, filling and superimposed substance conversions, such as chemical, biological or nuclear reactions

Process apparatuses through which fluid flows, such as, for example, vacuum-soldered aluminum-plate heat exchangers (“plate fin heat exchangers”, PFHE) are often used in process plants because of a large number of advantages (heat integration, compactness, costs).

Such apparatuses can be subject to thermal stresses, for example in the case of system malfunctions, special operating cases or start-up and shutdown processes, and can be exposed to high stress fluctuations, which can lead to material fatigue up to and including damage such as leakages, which can be associated with complex and cost-intensive repairs and unplanned system failures. In certain situations, apparatuses such as heat exchangers or columns may experience thermal or mechanical stresses that may lead to material fatigue.

In order to be able to detect or prevent malfunctions, faults, failures etc. as early as possible, the aim is to determine the mechanical stresses of apparatuses in order to determine in the course of a service life analysis, for example, a probability of failure or a remaining service life of the apparatuses. However, the determination of mechanical stresses in process apparatuses through which a fluid flows is usually associated with high level of complexity and a high time requirement and can usually take place not in real time, but only off-line.

DE 10 2009 042 994 Al discloses a method for monitoring a thermally stressed apparatus, for example a heat exchanger. In this case, a temperature is measured in each case at local, spatially limited points within the apparatus. Such temperature measurement values are compared to temperature setpoints or temperature limit values. Such temperature setpoints or temperature limit values can be determined from strength calculations for the local points. Maximum permitted stresses can be calculated from strength characteristics of the materials used for the apparatus and temperature limit values allowed therefrom for the local points can be determined. By comparing the temperature measurement values with the setpoint or limit values, local thermal stress exceedances and thus damage to the apparatus are to be prevented by timely introduction of safety measures.

DE 10 2009 042 994 A1 thus teaches measuring temperatures in an apparatus and comparing them with threshold values in order to be able to detect damage to the apparatus. However, such a temperature comparison represents a rather imprecise monitoring possibility. A genuinely precise determination of mechanical stresses would be desirable.

EP 2 887 168 A2 relates to the operation of machines such as gas turbine engines. Operating parameters of the machine are captured. Such captured operating parameters are used on the one hand to determine first properties of the machine with regard to machine wear. On the other hand, the captured operating parameters are used to determine second thermal properties of the machine, such as thermal stresses in the machine. A remaining service life of components of the machine is determined as a function of such first and second properties. Furthermore, EP 2 887 168 A2 teaches using an empirical thermal model of reduced order to evaluate information from sensors, which information may include temperatures of components of the machine. The model may include information such as stress curves of the machine components. The result of this model can be used together with the information from the sensors in order to calculate the remaining service life.

Such an empirical model of reduced order is often loaded with assumptions and simplifications. It would be desirable to be able to measure a temperature field with an accuracy that is adequate and to use it directly as an input variable for a stress calculation, in order to be able to precisely determine mechanical stresses in apparatuses for the purpose of a service life analysis.

### DISCLOSURE OF THE INVENTION

Against this background, the present invention proposes a method for calculating the strength and service life of a process apparatus through which a fluid flows, and also a computing unit and a computer program for carrying out the same having the features of the independent claims. Advantageous embodiments are the subject matter of the dependent claims and the following description.

The process apparatus through which a fluid flows can be designed in particular as a heat exchanger, in particular as a plate heat exchanger or spiral or coiled heat exchanger, or as a column (hollow, slender column with internal fittings) or as a phase separation apparatus (container with internal fittings). The apparatus can expediently be designed as a component of a process plant and can be connected to further system components, for example to further heat exchangers, columns or containers for phase separation.

Within the scope of the present invention, temperatures prevailing at several different points of the apparatus are measured in order to obtain temperature measurement values. For this purpose, a plurality of corresponding sensors are expediently arranged in or on the apparatus. In particular, a plurality of different temperature measurement values are thus captured during the ongoing operation of the apparatus, in particular at different points in the apparatus and at different points in time.

The temperature measurement values are used as boundary conditions in a finite element method in order to carry out a strength calculation. In the case of a mechanical strength calculation, as the result of a finite element method, in particular stresses and strains prevailing at a plurality of different points in a material of the apparatus are obtained, from which a remaining service life of the material of the apparatus can be estimated.

A remaining service life of the material of the apparatus is thus determined from the stress values obtained. Furthermore, within the scope of the present invention, the remaining service life is determined as a function of data relating to the apparatus, which were determined at a second time point, which is earlier than the first time point. In particular, in addition to the currently captured temperature measurement values, earlier data for the service life analysis are thus also taken into account in order to be able to estimate the remaining service life as precisely as possible. The earlier data can be stored, for example, in a memory unit, e.g. in a memory unit of a control device of the apparatus, or also in a remote computing unit, in particular in a cloud.

Particularly advantageously, the data relating to the apparatus comprise the results of finite element methods that were determined at the second, earlier time point. In order to determine the current mechanical stresses and the current remaining service life at the current first time point, the results of finite element methods carried out at the earlier time point are thus used particularly expediently.

Within the scope of the present invention, a self-learning algorithm is thus provided, which, for example, recognizes process boundary conditions already analyzed and finite element methods already carried out in the past and makes use of results that are already available. In particular, the stress values as result of the finite element method are therefore also stored together with associated boundary conditions in the memory unit for later use in the method. In particular, temperature measured values and/or temperature calculation values determined from the temperature measured values are used as boundary conditions. The temperature calculation values are preferably location- and/or time-dependent temperature differences, i.e. temporal or local temperature gradients. This is because it has been found that a service life consumption depends essentially on temperature gradients in the material.

An optimum of accuracy and performance is given by a hybrid model consisting of finite element methods for unknown operating cases and the reuse of the results of already performed stress analyses by a self-learning algorithm.

The reuse of earlier results can include in particular an interpolation or extrapolation of the boundary conditions or the adoption of earlier results from nearby boundary conditions.

In this connection, a sensitivity of the boundary conditions to the service life prediction is also preferably taken into account. If, for example, the sensitivity is high—i.e. even small changes have a significant effect—interpolation or extrapolation of the boundary conditions will be preferable. It goes without saying that here a recognized form of the relationships, for example linear, exponential, etc., can also be taken into account. On the other hand, if the sensitivity is weak—i.e. only very large changes have a significant effect—earlier results can also be adopted unchanged. Expediently, reuse always takes place in the direction of the greater service life consumption in order to avoid getting an underestimate.

In particular, the temperature measurement values can be input into the finite element method directly as boundary conditions or also indirectly, wherein the temperature measurement values are initially preprocessed, for example, and wherein the preprocessed temperature measurement values are used as boundary conditions.

For example, it is conceivable that the temperature measurement values are first projected onto a higher manifold with the aid of an intermediate model, for example by projecting measured 1D temperatures onto 2D or 3D temperatures.

Mechanical stresses and/or strains prevailing in the material of the process apparatus are thus determined, in particular in the form of stress levels or stress profiles and/or local strains. The service life of the process apparatus through which a fluid flows is largely determined on the basis of the number of stress changes and/or strains of a certain magnitude. Such changes typically occur when the apparatus is started up, when changing between different operating scenarios or as a result of process disturbances caused, for example, by machine or valve faults. In general, the service life consumed depends strongly on how the process is operated, whereby the operating personnel usually do not however have any clear indication of the influence of the operation on the stress levels occurring in the material of the apparatus and consequently on the expected service life.

Since temperatures prevailing in the apparatus are captured at a multiplicity of different points, temperature measurement values with a high temporal and spatial resolution can be captured in order, in particular, to specify as many boundary conditions as possible for the finite element method and to preferably enable as precise an image of the apparatus as possible. In particular, a temperature field of the entire apparatus can thus be precisely derived, which is used as the basis for the stress calculation. The temperature field can expediently be measured with sufficient accuracy and used directly as input variable for the stress calculation with the aid of the finite element method. A precise determination of the mechanical stress is thus made possible.

The service life calculation within the scope of the present invention is expediently not based on a temperature comparison or a comparison of captured temperatures with threshold values and furthermore in particular is not based on the evaluation of captured temperatures by means of empirical thermal models of reduced order, but rather on a numerical strength or stress calculation.

The finite element method (FEM) is a numerical method based on the numerical solution of a complex system of partial differential equations. Thereby, the apparatus is divided into a finite number of sub-regions of simple shape, i.e., into finite elements whose physical or thermo-hydraulic behavior can be calculated on the basis of their simple geometry. In each of the finite elements, the partial differential equations are replaced by simple differential equations or by algebraic equations. The system of equations thus obtained is solved in order to obtain an approximate solution of the partial differential equations.

During the transition from one element into the adjacent element, the physical behavior of the entire body is simulated by predetermined continuity conditions. The temperature measurement values are used as boundary conditions, in particular as industrial, thermo-hydraulic boundary conditions. Such boundary conditions dictate function values at boundaries or nodes between two elements or sub-regions. For this purpose, a correspondingly high number of temperature sensors is preferably provided in order to cover the apparatus with a sufficiently large number of temperature measurement values with high resolution and to specify as many boundary conditions as possible for the finite element method. In contrast to conventional applications, advantageously no complex thermo-hydraulic simulation model of the apparatus is thus required for generating the boundary conditions.

Complex thermo-hydraulic simulation models of the apparatus are conventionally required for a stress analysis of an apparatus in the course of the finite element method. The results of such thermo-hydraulic simulations are usually spatially resolved heat-transfer coefficients and temperatures, which can be used as boundary conditions for a stress analysis according to the finite element method. In the FEM model, a metal temperature distribution is then recalculated. However, such thermo-hydraulic simulation models are associated with a high outlay on work and development, require high computing capacities and often do not allow an exact image of the apparatus. Furthermore, in conventional apparatuses, there is often only limited instrumentation, in particular only a small number of installed sensors with a low spatial resolution, so that no precise temperature fields can be derived therefrom, but only a good match between simulation models and measurements. Thermo-hydraulic simulation models are therefore associated with a certain uncertainty and inaccuracy.

Within the scope of the present invention, however, no thermo-hydraulic simulation model is required, but rather the finite element method and the corresponding stress analysis are carried out as a function of temperature measurement values, which are captured directly during the operation of the apparatus. The present invention is based on the finding that, with sufficiently good instrumentation of apparatuses, in particular with a sufficiently large number of temperature sensors with high spatial resolution, boundary conditions for the finite element method and stress analyses can be derived directly from the process apparatus without having to set up thermo-hydraulic simulation models. The development outlay for the finite element method and the determination of the strain or mechanical stress can thus be kept low. Since thermo-hydraulic simulation models are thus expediently no longer needed, the outlay on work and development can be saved. Furthermore, the uncertainties and inaccuracies associated with the thermo-hydraulic simulation models can be avoided.

In particular, there is also the possibility of carrying out a model regression for the FEM model, in order to be able to keep computing effort for the finite element method at a low level. Alternatively or additionally, it is conceivable to carry out a model order reduction (MOR) in order to reduce the complexity of the FEM model, as a result of which the computing capacity required for the finite element method can be kept at a low level.

The stress analysis and service life analysis can be relocated by the present method, in particular into plant operation, and expediently in an automated manner. The measurements, which are the basis for the stress analysis and service life analysis, replace the thermo-hydraulic simulations, are more accurate with high temporal and spatial resolution and reflect the real driving operation.

The metal temperature distribution is thus itself measured within the scope of the present invention and the measured temperature is impressed on the FEM model as a boundary condition. The heat transfer is selected in particular to be so large that the metal temperature distribution recalculated by FEM corresponds to the measured one. In particular, temperature fields and heat-transfer coefficient fields (one- or multi-dimensional in space, stationary or transient) are required for stress analyses of thermal stress by means of finite element methods. If the heat-transfer coefficients are specified as arbitrarily large, it is possible to apply measured temperature profiles in the finite element method to the apparatus and to directly and very precisely capture the operating states actually passed through in process systems and to evaluate them on the stress or strain side. In particular, this is equally possible for stationary and transient operating conditions.

The present method provides an apparatus-related service life analysis, which can take place in particular on-line during the operation of the apparatus, which does not represent a stress regression of thermo-hydraulically simulated process states, but which in particular enables a continuous service life analysis in real system operation.

The present invention enables an apparatus-related on-line service life analysis, which does not represent a stress regression of thermo-hydraulically simulated process states, but enables a continuous and self-learning service life analysis in real system operation. For this purpose, measurements are used directly as industrial, thermo-hydraulic boundary conditions for FEM simulation models for stress analysis instead of complex thermo-hydraulic simulation models, which usually provide the input in a conventional manner. Furthermore, the action chain from the measurement, via the FEM simulation, stress analysis and service life assessment is automated (e.g. as a concurrent cloud service). Furthermore, a self-learning algorithm is provided, which recognizes process boundary conditions already analyzed and FEM analyses already carried out in the past and makes use of results that are already available, in particular regressing them directly or around an operating point.

Furthermore, the data relating to the apparatus advantageously comprise temperature measurement values and/or temperature calculation values and/or mechanical stresses and/or strains and/or a remaining service life, which were respectively determined at the second, earlier time point. The self-learning algorithm for calculation of strength and service life at the current first time point can thus expediently fall back on earlier measured values or simulation results that are already available.

Temperature distributions in the apparatus are preferably obtained as temperature measurement values, in particular temperature profiles or temperature fields. In particular, such temperature distributions or temperature profiles can correlate with the individual elements or sub-regions of the finite element method and expediently map a profile of the temperature within and/or between such individual elements and can be specified as boundary conditions. In particular, a temperature field of the entire apparatus is thus captured with sufficient accuracy and used directly as an input variable for the stress calculation by means of the finite element method.

The temperature measurement values are preferably captured by means of fiber-optic temperature sensors, in particular by means of fiber Bragg grating sensors. Temperature distributions, temperature profiles or temperature fields along a glass fiber are captured in such fiber-optic temperature sensors. Fiber-optic temperature sensors can be based on the Raman effect, whereby light is scattered in the glass fiber due to density fluctuations. In the backscatter, in addition to the elastic scattering component due to Rayleigh scattering on the same wavelength as the irradiated light, additional components are also found at other wavelengths, which due to Raman scattering are coupled to molecular oscillation and thus to the local temperature. Fiber Bragg grating sensors are based on the temperature-dependent change in the refractive index. The wavelength of the irradiated light shifts here with the temperature and the relative expansion of the glass fiber.

The boundary conditions for the finite element method are preferably captured in the form of the temperature measurement values during the ongoing operation of the apparatus. The boundary conditions are thus expediently specified in particular by ongoing measurements and not by complex thermo-hydraulic simulation models.

The finite element method and/or the determination of mechanical stress and/or the determination of the remaining service life are advantageously carried out on-line during the operation of the apparatus. In the conventional way, an ongoing service life analysis of the apparatus is not possible due to the complicated thermo-hydraulic simulation models required during operation. Within the framework of the present method, it is preferably possible to determine in real time or on-line the mechanical stresses in the material of the process apparatuses through which a fluid flows and therefrom to continuously estimate the remaining service life. In particular, a subsequent and/or if necessary a requested analysis on the basis of existing data is also possible as an alternative to or in addition to real-time analysis.

Preferably, the execution of the finite element method and/or the determination of mechanical stress and/or the determination of the remaining service life are carried out in a remote computing unit. In particular, for this purpose, the captured temperature measurement values can be transmitted to the non-local, remote computing unit from the apparatus or from a local computing unit, for example a control device, arranged on the apparatus or in its vicinity. In this connection, a remote computing unit is to be understood in particular as a computing unit, which is not attached to the apparatus, can be located at a very great distance therefrom and does not necessarily have to be located in the same building. In particular, the remote computing unit is designed as a server, expediently as part of a remote, distributed computing unit system in the sense of cloud computing. By means of cloud computing, IT infrastructures, such as data storage facilities, can be dynamically adapted to demand and made available via a network. In particular, the local computing unit can therefore be built small and the more complex computing operations can be outsourced to the remote computing unit, that is to say to the cloud. In particular, a chain of action from the measurement of temperature measurement values, via the finite element method, stress analysis, to the service life assessment can thus be automated and provided, for example, as a concurrent cloud service. Alternatively or additionally, it is conceivable to carry out model regression and/or model order reduction (MOR) for the FEM model, which require little computing effort and can also be carried out in a small local computing unit.

A computing unit according to the invention, e.g. a control device of an apparatus, is designed, in particular in terms of programming, to carry out a method according to the invention.

The implementation of the method in the form of software is also advantageous, since this makes particularly low costs possible, in particular if an executing control unit is used for further tasks as well and is therefore available anyway. Suitable data carriers for providing the computer program are in particular magnetic, electrical and optical data carriers such as hard disks, flash memories,

EEPROMs, DVDs and the like. A download of a program via computer networks (Internet, intranet, etc.) is also possible.

Further advantages and embodiments of the invention arise from the description and the accompanying drawing.

It is to be understood that the features mentioned above and below may be used not only in the particular combination specified, but also in other combinations or by themselves, without departing from the scope of the present invention.

The invention is schematically represented in the drawing using exemplary embodiments and will be described in detail below with reference to the drawing.

### DESCRIPTION OF THE FIGURES

FIG. 1 shows, schematically and in perspective, a process apparatus through which a fluid flows designed as a plate heat exchanger, the remaining service life of which can be determined in accordance with a preferred embodiment of a method according to the invention.

FIG. 2 shows a preferred embodiment of a method according to the invention as a block diagram.

### DETAILED DESCRIPTION OF THE DRAWING

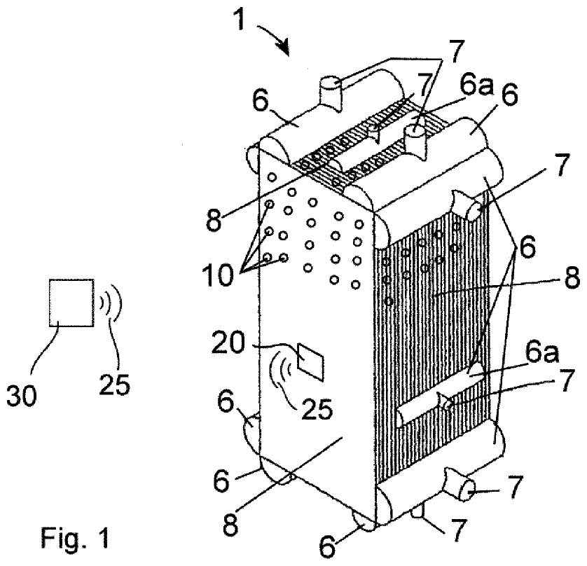

FIG. 1 shows an external view of a process apparatus here taking the form of plate heat exchanger 1. The plate heat exchanger has a cuboid central body 8 with a length of, for example, several meters and a width or height of, for example, approximately one or a few meters. Attachments 6 and 6a are visible on top of the central body 8, on its sides, and underneath the central body 8. The attachments 6 and 6a located underneath the central body 8 and on the side facing away from the side depicted are partially concealed.

A fluid or process stream can be supplied to or removed again from the plate heat exchanger by connecting pieces 7. The attachments 6 and 6a serve for distributing the fluid introduced through the nozzles 7, or for collecting and concentrating the fluid to be removed from the plate heat exchanger. The various fluid streams then exchange thermal energy within the plate heat exchanger.

The plate heat exchanger shown in FIG. 1 is designed to feed fluid streams past each other in separate passages for the purpose of heat exchange. One part of the streams can be guided past one another in opposite directions, another part crosswise or in the same direction.

The central body 8 is essentially an arrangement of separating plates, heat exchange profiles (so-called fins) and distributor profiles. Separating plates and layers with profiles alternate. A layer having a heat exchange profile and distributor profiles is called a passage.

The central body 8 thus has passages and separating plates arranged alternately parallel to the flow directions. Both the separating plates and the passages are usually made of aluminum. To their sides, the passages are closed off by side strips made of aluminum, so that a side wall is formed by the stacking design with the separating plates. The outside passages of the central body are closed off by a cover made of aluminum (cover plate) lying parallel to the passages and the separating plates.

Such a central body 8 can be produced, for example, by applying a solder to the surfaces of the separating plates and then stacking the separating plates and the passages on top of each other alternately. The covers cover the stack 8 at the top or bottom. The central body has then been soldered by heating in an oven.

At the sides of the plate heat exchanger, the distributor profiles have distributor profile accesses (so-called headers or half-shells). The fluid may be introduced through these from the outside into the associated passages via the attachments 6 and 6a and connecting pieces 7 or also removed again. The distributor profile accesses are concealed by the attachments 6 and 6a.

The plate heat exchanger is equipped with a sufficient number of temperature sensors 10, here taking the form of fiber Bragg grating sensors, in order to capture temperature profiles or temperature fields or temperature profiles as temperature measurement values. Although in FIG. 1 the temperature sensors 10 have relatively large distances between each other, in practice these are advantageously closely distributed in order to be able to measure the temperature distribution with sufficient resolution.

The temperature sensors 10 are coupled in a data-transmitting manner to a computing unit 20, which may be designed, for example, as a control device of the heat exchanger 1. The computing unit 20 is in turn coupled to a remote computing unit 30 (“cloud”) in a data-transmitting manner, which is designed in particular as a server, expediently as part of a remote, distributed computing unit system in the sense of cloud computing. The control device 20 is expediently in communication with the remote computing unit 30 via a network 25, in particular via the Internet.

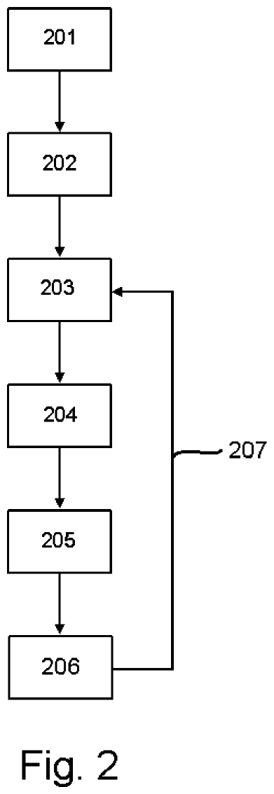

In FIG. 2, a preferred embodiment of a method according to the invention is schematically represented as a block diagram, in the course of which a remaining service life of the heat exchanger 1 is determined.

In a step 201, temperature profiles or temperature fields of the heat exchanger 1 are captured as temperature measurement values by means of the fiber Bragg grating sensors 10 and transmitted from the sensors 10 to the computing unit 20.

In step 202, such temperature measurement values are transmitted from the computing unit 20 to the remote computing unit or to the cloud 30.

In the remote computing unit 30, a finite element method is executed in step 203 as a function of the captured temperature measurement values. The temperature measurement values, which are captured on-line during the ongoing operation of the heat exchanger 1, are used here as boundary conditions for the finite element method.

In step 204, mechanical stresses prevailing at different locations in the heat exchanger 1 are determined as results of the finite element method from the remote computing unit 30. In the course of the finite element method, the heat exchanger 1 is divided into finite number of sub-regions or finite elements. At the transition between the individual finite elements the physical or thermo-hydraulic behavior of the entire heat exchanger 1 is simulated by predetermined continuity conditions. In the remote computing unit 30, a complex system of partial differential equations is thus numerically solved in the course of the finite element method in order to determine the mechanical stress in the heat exchanger 1 as a result.

In step 205, a remaining service life of the heat exchanger 1 is determined in the remote computing unit 30 as a function of this determined mechanical stress.

The service life of the heat exchanger 1 is largely determined on the basis of the number of stress changes of a certain magnitude which occur, for example, during start-up, when changing between different operating scenarios or as a result of process disturbances caused, for example, by machine or valve faults.

The remaining service life of the heat exchanger 1 can therefore be estimated in step 205 as a function of the mechanical stress or stress levels or stress curves prevailing in the material of the heat exchanger 1 determined in step 204.

For detailed explanations of how mechanical stresses of a heat exchanger can be determined with the aid of the finite element method and how the remaining service life of a heat exchanger can be determined from mechanical stresses, reference is made at this point, for example, to Freko, 2014 (Freko “Optimization of lifetime expectance for heat exchangers with special requirements” Proc. IHTC15 9791, 2014), Wang et al, 2006 (Wang, C. G. and S. Shan, Review of metamodeling techniques in support of engineering design optimization, J. Mechanical Design (2006)), Hölzl, 2012 (Hölzl, Reinhold. 2012. Lifetime estimation of aluminum plate fin heat exchangers. in: Proceedings of the ASME 2012 Pressure Vessels & Piping Division Conference) and to patents EP 1 830 149 B1 and U.S. Pat. No. 7,788,073 B2.

The steps 203 to 205, i.e. the execution of the finite element method, the determination of mechanical stress and the determination of the remaining service life, are carried out by the remote computer unit 30 on-line, that is to say during operation of the heat exchanger 1.

Furthermore, in step 206, the remote computing unit 30 stores the temperature measurement values received in step 202 along with the results of steps 203 to 205, that is, the executed finite element method, the determined mechanical stress and the determined remaining service life, for example, in a memory unit in the remote computing unit 30.

Such stored data are used at a later time point for a renewed determination of the remaining service life, indicated by reference sign 207 when in other words steps 203 to 205 are carried out again at a later time point.

A self-learning algorithm is thus provided which recognizes process boundary conditions already analyzed and finite element methods already carried out in the past and makes use of results that are already available.

The preferred embodiment of the present invention shown in FIG. 2 thus relates to a method for continuously determining the service life consumption of process apparatuses such as the heat exchanger 1 which are subjected to thermal stress, on the basis of sufficiently many temperature measurements or sufficiently precise determination of the temperature field, e.g. by means of fiber Bragg grating sensors, in the course of an automated finite element analysis and by means of a self-learning algorithm.

Thereby, as industrial, thermo-hydraulic boundary conditions for the finite element method for stress analysis performed in step 203, on-line measurements from step 201 are used directly instead of complex thermo-hydraulic simulation models.

The action chain from the measurement 201 via the finite element method 203, the stress analysis 204 and the service life assessment 205 is automated, for example as a concurrent cloud service, in particular in the course of a self-learning algorithm, which recognizes process boundary conditions already analyzed in the past and FEM analyzes carried out and uses results (207) that are already available.

The algorithm can operate, for example, according to the following operating principle: If a current temperature measurement or a temperature distribution or temperature gradient distribution defined by currently measured temperature measurement values is sufficiently similar to a temperature or temperature gradient distribution already measured in the past and deviates from this at most by a predetermined maximum permissible deviation or uncertainty, it will be possible to use the corresponding result relating to the service life influence already determined in the past.

Alternatively, the case may arise that a temperature or temperature gradient distribution defined by currently measured temperature measurement values is not sufficiently similar to a temperature or temperature gradient distribution already measured in the past and thus deviates from all temperature or temperature gradient distributions already measured in each case by more than the predetermined maximum permissible deviation or uncertainty. If, however, in this case the current temperature distribution lies between two temperature distributions already determined in the past, the results of which have already been investigated with regard to the service life influence, then an interpolation will expediently be carried out. Otherwise, a rigorous recalculation will take place for the current temperature distribution.

An apparatus-related on-line service life analysis is thus made possible, which does not represent a stress regression of thermo-hydraulically simulated process states, but enables a continuous and self-learning service life analysis in real plant operation.

1. A method for calculating the strength and the service life of a process apparatus through which fluid flows,
wherein at a first time point temperatures prevailing at a plurality of different points of the apparatus are measured in order to obtain temperature measurement values,
wherein the temperature measurement values are input into a finite element method as boundary conditions, in order to determine mechanical stresses prevailing at a plurality of different points in a material of the apparatus as stress values,
wherein a remaining service life of the material of the apparatus is determined from the obtained stress values,
wherein the remaining service life of the apparatus is further determined as a function of data relating to the apparatus determined at a second time point which is earlier than the first time point.

2. The method according to claim 1, wherein the data relating to the apparatus comprise the results of finite element methods determined at the second time point.

3. The method according to claim 1, wherein the data relating to the apparatus further comprise temperature measurement values and/or temperature calculation values and/or mechanical stresses and/or strains and/or a remaining service life which were respectively determined at the second time point.

4. The method according to claim 1, wherein temperature distributions in the apparatus are obtained as temperature measurement values.

5. The method according to claim 1, wherein the temperature measurement values are obtained by means of fiber-optic temperature sensors, in particular by means of fiber Bragg grating sensors.

6. The method according to claim 1, wherein the boundary conditions for the finite element method are obtained in the form of the temperature measurement values during the ongoing operation of the apparatus.

7. The method Method according to claim 1 any one of the preceding wherein the execution of the finite element method and/or the determination of the mechanical stress and/or the determination of the remaining service life are carried out during the operation of the apparatus and/or in a remote computing unit.

8. The methodaccording to claim 1, wherein the process apparatus through which a fluid flows is designed as a heat exchanger, in particular as a plate heat exchanger or spiral or coiled heat exchanger, or as a column or as a container for phase separation.

9. The method according to claim 1, wherein no thermo-hydraulic simulation model is created, wherein the finite element method and the determination of mechanical stress are carried out without a thermo-hydraulic simulation model, wherein, in particular, boundary conditions for the finite element method are not determined by a thermo-hydraulic simulation model.

10. A computing unit with means for carrying out the method according to claim 1.

11. A computing program that causes a computing unit to perform the method according to claim 1 when it is executed on the computing unit.

12. A machine-readable storage medium having a computer program according to claim 11 stored on it.
